(19) United States
(12) Patent Application Publication
(10) Pub. No.: US 2003/0026417 A1
(43) Pub. Date: Feb. 6, 2003

(54) Communication system having line and acoustic echo canceling means with spectral post processors

(76) Inventors: Harm Jan Willem Belt, Leuven (BE); Cornelis Pieter Janse, Eindhoven (NL); Rene Petrus Marie Bakx, Eindhoven (NL)

Correspondence Address: U.S. Philips Corporation, 580 White Plains Road, Tarrytown, NY, 10591, US

(21) Appl. No.: 10/196,097

(22) Filed: Jul. 16, 2002

(30) Foreign Application Priority Data
Jul. 20, 2001 (EP) 01202789.2

(51) Int. Cl. H04M 1/00; H04M 9/00

(52) U.S. Cl. 379/387.01

(57) ABSTRACT

A communication system is described, which is provided with stations mutually coupled through a communication line, wherein at least one of the stations comprises acoustic means embodied by one or more loudspeakers and microphones, and echo canceling (EC) means embodied by line EC means and acoustic EC means. Each such EC means is respectively coupled to respective inputs of individual subtracters having respective subtractor outputs. The EC means are further embodied by respective EC spectral post processors each coupled to the respective subtractor outputs.

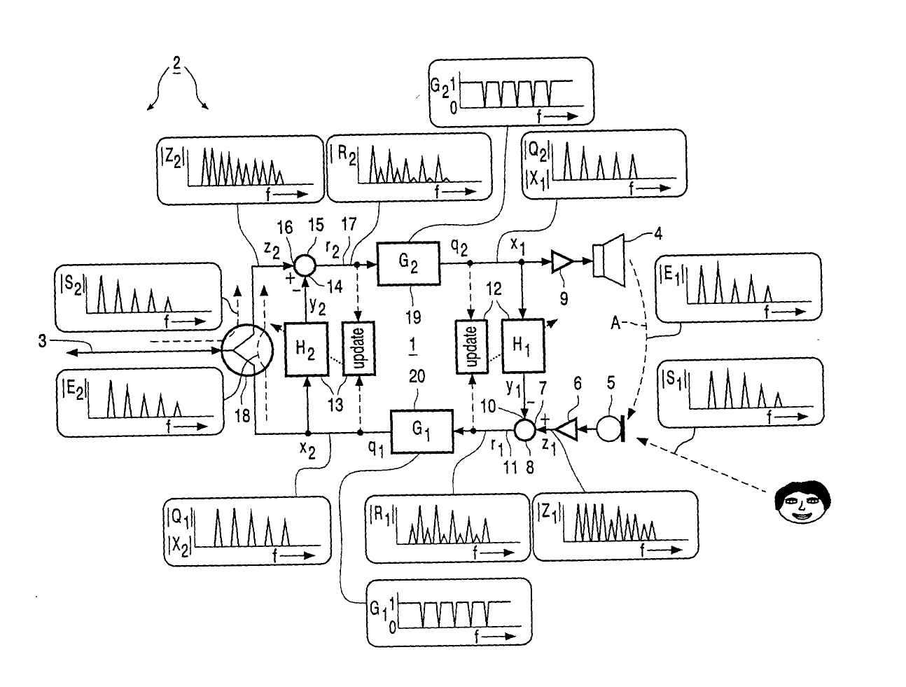

A solution for combined acoustic and line echo cancellation in full duplex communication systems is provided, where the loop gain is kept stable and smaller than unity across the full frequency range, even during start-up of the system, while various different operational conditions may be complied with.

The present invention relates to a communication system provided with stations mutually coupled through a communication line, wherein at least one of the stations comprises acoustic means embodied by one or more loudspeakers and microphones, and echo canceling (EC) means embodied by line EC means and acoustic EC means, each such EC means respectively coupled to respective inputs of individual subtracters having respective subtractor outputs.

The present invention also relates to a station according to the invention for application in the above identified communication system.

Such a communication system is known from EP-A-0 765 067. The known communication system concerns a speakerphone system provided in a station which is coupled to a far end station through a communication line. The speakerphone system comprises a loudspeaker and a microphone as acoustic means and echo canceling, hereafter abbreviated with EC, means coupled between the acoustic means and the communication line. The EC means comprises acoustic EC means essentially coupled parallel to the acoustic means and coupled to a subtracting input of a subtracter. The subtracter has an output coupled to the communication line. The EC means also comprises communication line EC means coupled between the communication line and a subtracting input of another subtracter, which also has an output. The latter output is coupled to the loudspeaker. In addition the station is provided with a transmit automatic gain control and a receive automatic gain control, both in turn coupled to a central controller for controlling the gain of said gain controls during transmit and receive cycles respectively. Thus a loop gain processing scheme is being defined wherein gain values in both an acoustic EC loop and a line EC loop are being calculated and compared to one another, in order to secure stability in the speakerphone and control the respective gains separately during said transmit and receive cycles.

It is a disadvantage of the known communication system that various separate automatic gain controls, controllable attenuators and a central controller are needed, which have to be controlled separately during each cycle. This means a continuously switching of several circuits and gains, which will lead to inevitable loop and control delays in the known communication system. This problem is severed in situations wherein double talk arises of both far end and near end speakers. In addition it is a disadvantage of the known communication system that full duplex is not possible.

Therefore it is an object of the present invention to provide an improved communication system capable of effectively canceling line and acoustic echoes under varying circumstances.

Thereto the communication system according to the invention is characterized in that the EC means are further embodied by respective EC spectral post processors each coupled to the respective subtractor outputs.

It is an advantage of the communication system according to the present invention that a solution for combined acoustic and line echo cancellation in communication systems is provided, where the loop gain is kept smaller than unity across the full frequency range while various different operational conditions such as double talk may be complied with. With the properly programmed EC spectral post processors the residual acoustic echoes can be suppressed while full-duplex operation remains possible. Even during start-up phase of the system, wherein the line EC means and the acoustic EC means have adaptive filter coefficients which have not yet converged the loop gain is automatically reduced by both EC spectral post processors.

In addition when the loop gain is kept small by the EC post processors this leads to a correct stable convergence of the filter coefficients of the line and acoustic EC means. Furthermore when the line and acoustic EC means filter coefficients are suddenly no longer optimal due to path changes, both post processors remain to suppress residual echoes and together automatically without requiring additional hard- or software keep the loop gain small. Under these circumstances the non optimal line and acoustic EC means can re-converge stable and in a normal manner.

An embodiment of the communication system according to the invention is characterized in that the EC spectral post processors are arranged as at least partly complementary operating frequency dependent attenuators.

Advantageously it happens during double talk that at a certain frequency the one EC post processor is attenuating while the other has unity gain, which is in a way complementary to the behavior of the other EC post processor regarding other frequencies.

A further embodiment of the communication system according to the invention is characterized in that the communication is a full duplex communication system.

Advantageously even with full duplex operation also during double talk of both the far end and the near end speaker loop stability can be guaranteed.

A preferred embodiment of the communication system according to the invention is characterized in that the communication system is a speakerphone system, in particular a hands free communication system.

It is an advantage of the preferred embodiment of the invention that in cases wherein loudspeaker and microphone amplifier gains are relatively large to suit possible hands free operation, also during full duplex and/or double talk situations stability can be guaranteed and possible howling is effectively suppressed.

At present the communication system according to the invention will be elucidated further together with its additional advantages, while reference is being made to the appended drawing, wherein similar components are being referred to by means of the same reference numerals. In the drawing the sole FIGURE shows a schematic diagram with example signal magnitude spectra therein of a station in a communication system according to the invention, comprising acoustic and line EC means having spectral post processors.

The FIGURE shows a station 1 for application in a communication system 2, which may be a hands-free speech communication system. The communication system 2 comprises stations like 1, mutually coupled through a communication line 3, such as a telephone line. The station 1 comprises a acoustic means having at least one loudspeaker 4 and microphone 5. A near end speaker generates a wanted signal, which is amplified by an amplifier 6 and then fed to an input 7 of a subtracter 8. Similarly a loudspeaker signal x₁ is amplified by an amplifier 9 and then fed to the loudspeaker 4. The subtracter 8 has a further input 10 and an output 11. Acoustic EC means 12 are coupled to the subtracter input 9 for simulating an acoustic echo from the far end speaker arising over an acoustic path A between the loudspeaker 4 and the microphone 5. A resulting unwanted echo, that is at least a first linear part thereof is simulated by the EC means 12 to reveal an acoustic echo cancelled signal r₁ on subtracter output 11.

Also the station 1 comprises line EC means 13 coupled to an input 14 of a further subtracter 15. The subtracter 15 has a second input 16 and an output 17. The station 1 is coupled to the communication line 3 through a fork circuit or hybrid 18 as shown. Generally a main part of a signal x₂ containing the wanted near end speech signal is fed to the far end station. However due to improper network impedance matching in the hybrid 18 a generally small part thereof is reflected on input 16. The EC means 13 simulate this line echo as y₂ to reveal a line echo cancelled signal r₂ on subtracter output 17.

In addition the station 1 comprises two EC spectral post processors 19 and 20, whose operation in relation to an improving of the stability of the above identified echo canceling mechanisms will be explained hereafter. Namely stability is in particular a major problem as the loudspeaker and microphone amplifier 6, 9 gains are relatively large to suit a possible hands-free option. Such a hands free system suffers from a large acoustic coupling between the loudspeaker 4 and the microphone 5, giving rise to substantial acoustic echoes. Consequently, the microphone signal z₁ is composed of a desired component, the near-end signal, and an undesired component, the acoustic echo resulting from a far-end signal. To suppress the acoustic echo two classes of solutions exist in the literature, namely half- and full-duplex algorithms.

With half-duplex solutions either the loudspeaker signal or the microphone signal or both are attenuated, where the attenuation is controlled by a controller which ensures that during near-end activity the near-end signal is passed, that during far-end activity the far-end signal is passed, and that an echo is always attenuated by at least a certain amount. The drawback of half-duplex systems is that during double talk periods (when both near-end and far-end are simultaneously active) one side of the communication channel 3 is attenuated.

Full-duplex solutions allow for two-way communications even during double talk periods. Full-duplex solutions are based on the adaptive filter means 12 which process the far-end signal such that its output y₁ resembles as closely as possible the true acoustic echo. The filter coefficients are adaptively optimized to deal with changing acoustics.

Many speech communication systems 2 (currently mostly not with the hands-free option) contain an analog communication channel or line interface with said hybrid 18. The hybrid transmits the near-end signal to the far-end side and receives the far-end signal for reproduction at the near-end side. Unfortunately as noted above, due to improper network impedance matching in the hybrid 18, the transmitted near-end signal is reflected and an echo is received. Again, just like acoustic echoes, these line echoes can be dealt with by either half- or full-duplex solutions, where half-duplex solutions are based on controlled attenuation and full-duplex solutions are based on adaptive filtering. With echo cancellation, especially so with acoustic echo cancellation, residual echoes always remain. To combat these residual echoes there exists a very robust spectral post-processing algorithm called the Dynamic Echo Suppressor (DES). Such a DES filter is exemplified in WO 97/45995, whose relevant content is included here by reference thereto. DES provides a frequency-dependent attenuation of the microphone signal, where the attenuation is largest in frequency bands where the echo-to-near-end signal power ratio is largest. More specifically, DES spectrally subtracts a source of interference (echo) from the residual signal r₁, whereas a reference for the source of interference one can either take y₁ or x₁. The real, frequency dependent attenuation function G₁(f) implemented for i=1 as G₁(f) in EC spectral processor 20, follows from a spectral subtraction rule and is of the general form:

Gᵢ(f)=max[{{|Zᵢ(F)|−γₑᵢ|Y₁(f)|}/|Rᵢ(f)|},0] (1)

with |Zᵢ(f)|, |Yᵢ(f)| and |Rᵢ(f)| for i=1 being the short-time magnitude spectra of the near-end signal z₁, the estimated echo signal y₁ and the residual signal r₁, respectively. The constant γₑᵢ is the echo over-subtraction factor and is usually chosen somewhat larger than unity. Any local signal component in z₁—not due to an echo of x₁—remains (mostly) unaffected. When x₁ is zero we get that the spectrum |Y₁(f)|=0 and |Z₁(f)|=|R₁(f)| so that G₁(f)=1. In this case DES leaves the signal r₁ unaffected. All this happens independently for all frequency bins. With the DES algorithm implemented in EC spectral post processor 20 the residual acoustic echoes can be suppressed while full-duplex operation remains possible.

In some modern speech communication systems the hands-free option is combined with an analog line interface 18. An example of such a system is a hands-free DECT phone. With the large loudspeaker and microphone amplifier 6, 9 gains associated with the hands-free option, such a combined system can have a loop gain that is considerably larger than unity, which results in howling. Applying conventional full-duplex solutions (without DES) for the two separate acoustic and line echo cancellation problems has shown to give rise to the following difficulties:

1) At start-up, when the adaptive filter coefficients of both the acoustic and line echo canceller means 12, 13 have not yet converged, the loop gain is larger than unity and howling occurs.

2) With howling the x- and r-signals of each adaptive filter means 12, 13 are highly correlated (because xᵢ is directly due to rᵢ), and this fact gives rise to serious convergence problems of these adaptive filter means 12, 13. With improperly converged adaptive filters the loop gain remains large. As a result, the overall system will remain to show howling instabilities and convergence problems remain.

3) In a situation where both adaptive filters means 12, 13 have converged properly and the resulting loop gain is much smaller than unity, a sudden change in the (acoustic or electric) path can cause the loop gain to increase. This can successively give rise to some howling, increased correlation between the xᵢ- and rᵢ-input signals of the adaptive filters 12, 13, some divergence of adaptive filter coefficients, more howling, etc . . .

The two post processor means 19, 20 wherein the respective DES algorithms are separately implemented more or less have complementary attenuations in single talk situations. This is explained next. Assume that there is near-end single talk, meaning that someone is speaking on the microphone while the hybrid 18 receives a zero-valued or very small far-end signal. In this situation with equation (1) the filter means 20 applies no attenuation (G₁(f)=1 at all frequencies f) because |Y₁(f)|=0 and |Z₁(f)|=|R₁(f)|. However, the filter means 19 is suppressing since |Y₂(f)|>0. By this mechanism the loop gain is kept small. The same reasoning can be done for the case of far-end single talk, where we then find that G₂(f)=1 and 0≦G₁(f)<<1.

With this explanation in mind, we can next explain how the invention deals with the three respective difficulties given above.

1) At start-up, if the initial adaptive filter coefficients are zero, the DES post processor means 19, 20 will not provide any attenuation (so G₁(f)=1) because |Yᵢ(f)|=0 and |Z₁(f)|=|Rᵢ(f)| in equation (1) for i=1, 2 respectively. The consequence is initial howling followed by divergence of the adaptive filter coefficients. However, immediately after some filter coefficient divergence the |Yᵢ(f)| becomes positive for both DES's 19, 20. Alternatively, one could initialize the adaptive filter coefficients with some sensible non-zero numbers to also achieve that |Yᵢ(f)|>0, or one could take during the start-up phase that |Yᵢ(f)| is some portion of |Xᵢ(f)|. With a positive |Yᵢ(f)| the DES's 19, 20 start suppressing residual echos and keep the loop gain small so that howling is prevented. In this phase, where the adaptive filters 12, 13 have not yet converged but have non-zero coefficients, the DES processors 19, 20 behave such that the system effectively is temporarily operating in half-duplex mode.

2) With the loop gain kept small by the DES processors 19, 20, the correlation between the xᵢ- and rᵢ-signals is removable by the adaptive filters (xᵢ is no longer due to rᵢ, i=1, 2) leading to correct convergence of their coefficients, where after full duplex operation is possible.

3) When the adaptive filter 12, 13 coefficients are suddenly no longer optimal due to path changes, both DES processors 19, 20 remain to suppress residual acoustic and line echoes and together keep the loop gain small. Under these circumstances the non-optimal adaptive filter(s) 12, 13 can re-converge in a normal manner.

Since all this is done independently for each frequency band, it happens during double talk that at a certain frequency the first DES 19 is attenuating while the other DES 20 has unity gain, and that this is exactly the other way around at another frequency. Communication system 2 allows for hands-free two-way communication during double talk, thus for real full-duplex communication, while at the same time loop stability is guaranteed}. This is an important aspect of the system 2.

With reference to the same FIGURE an example will be given during a double talk period in order to demonstrate that hands-free full-duplex operation is possible while loop stability remains guaranteed. The depicted plots are the magnitude spectra of the signals in the scheme measured across a certain short time frame. The spectra due to the far-end signal s₂ are depicted in white, and the spectra due to the near-end signal s₁ are depicted in black. For clarity of the example the spectra due to s₁ and s₂ do not overlap. In practice these spectra may and will overlap, and in such cases, instead of full attenuation, the DES processors 19, 20 will attenuate at a certain frequency where the amount of attenuation depends on the echo-to-local-signal power ratio at that frequency (more attenuation when the echo is relatively larger).

Let us start by observing the spectrum |S₂| of the far-end signal s₂. Directly after the hybrid this spectrum is polluted by the line echo e₂ of the near-end signal s₁: |Z₂|=|S₂+E₂|. The adaptive filter 13 only partly succeeds in removing e₂ from z₂ which can be observed in the example from the residual spectrum |R₂|. The DES 20 then removes residual echoes by applying the real spectral gain function G₂. The latter is steered by the formula in equation (1) and puts an attenuation at frequencies where echoes are estimated to occur. Running clock-wise through the diagram of the sole FIGURE it can thus be seen that s₁ gets sufficient attenuation while s₂ reaches the loudspeaker 4 and can be heard by the near-end speaker.

In a similar way one may observe the spectra in the diagram starting with |S₁|, and it can then be seen that running clock-wise through the diagram s₂ gets sufficient attenuation while s₁ reaches the hybrid 18 and can be heard by the far-end speaker. The two DES processors 19, 20 thus more or less operate complementary: when one DES attenuates at a certain frequency the other DES passes the signal at that frequency.

The communication system 2 can be applied in hands-free speech communication systems which are interfaced with an analog communication channel, and provides a solution for the howling and the adaptive filter convergence problems. Applications are corded systems such as hands-free telecom terminals or cordless systems such as hands-free DECT phones.

The algorithm can readily be extended to the multi-channel case, with multiple loudspeakers 4 or multiple microphones 5 or both, as long as one puts a DES 19/20 at each residual signal in the scheme.

Whilst the above has been described with reference to essentially preferred embodiments and best possible modes it will be understood that these embodiments are by no means to be construed as limiting examples of the devices concerned, because various modifications, features and combination of features falling within the scope of the appended claims are now within reach of the skilled person.

1. A communication system (2) provided with stations (1) mutually coupled through a communication line (3), wherein at least one of the stations (1) comprises acoustic means (4, 5) embodied by one or more loudspeakers (4) and microphones (5), and echo canceling (EC) means (12, 13, 19, 20) embodied by acoustic EC means (12) and line EC means (13), each such EC means (12; 13) respectively coupled to respective inputs (10; 14) of individual subtracters (8; 15) having respective subtractor outputs (11, 17), characterized in that the EC means (12, 13, 19, 20) are further embodied by respective EC spectral post processors (19, 20) each coupled to the respective subtractor outputs (17, 11).

2. The communication system (2) according to claim 1, characterized in that the EC spectral post processors (19, 20) are arranged as at least partly complementary operating frequency dependent attenuators.

3. The communication system according (2) to claim 1 or 2, characterized in that the communication system (2) is a full duplex communication system.

4. The communication system (2) according to one of the claims 1-3, characterized in that the communication system is a speakerphone system.

5. The communication system (2) according to one of the claims 1-4, characterized in that the communication system is a hands free communication system.

6. A station (1) for application in the communication system (2) according to one of the claims 1-5.
